(19) United States
(12) Patent Application Publication
(10) Pub. No.: US 2022/0391836 A1
(43) Pub. Date: Dec. 8, 2022

(54) Package Tracking System

(71) Applicant: Banipal Shamoon, Winnetka, CA (US)

(72) Inventor: Banipal Shamoon, Winnetka, CA (US)

(21) Appl. No.: 17/831,466

(22) Filed: Jun. 3, 2022

Related U.S. Application Data
(60) Provisional application No. 63/196,652, filed on Jun. 3, 2021.

(51) Int. Cl. G06Q 10/08; H04W 4/029; H04W 4/80

(52) U.S. Cl. CPC G06Q 10/0833; H04W 4/029; H04W 4/80

(57) ABSTRACT

The present invention relates generally to the field of tracking devices. More specifically, the present invention relates to a package tracking system. The system is primarily comprised of at least one sleeve and at least one tracking device with a body, further comprised of at least one transmitter and at least one label. In the preferred embodiment, the tracking device is encased within the sleeve. The sleeve is preferably adhesive and can therefore be placed inside a package and secured within a package. The transmitter of the tracking device can be activated once inside the package to allow a user to view the GPS location of the package via a mobile application. In this manner, a package the tracking device is in can be tracked if said package is stolen after delivery of the package, but before the package could be received by a consumer.

### CROSS-REFERENCE TO RELATED APPLICATION

The present application claims priority to, and the benefit of, U.S. Provisional Application No. 63/196,652, which was filed on Jun. 3, 2021, and is incorporated herein by reference in its entirety.

### FIELD OF THE INVENTION

The present invention relates generally to the field of tracking devices. More specifically, the present invention relates to a package tracking system. The system is primarily comprised of at least one sleeve and at least one tracking device with a body further comprised of at least one transmitter and at least one label. In the preferred embodiment, the tracking device is encased within the sleeve. The sleeve is preferably adhesive and can therefore be placed and secured inside a package. The transmitter of the tracking device can be activated once inside the package to allow a user to view the GPS location of the package via a mobile application. In this manner, a package the tracking device is in can be tracked if said package is stolen after delivery of the package, but before the package could be received by a consumer. Accordingly, the present disclosure makes specific reference thereto. Nonetheless, it is to be appreciated that aspects of the present invention are also equally applicable to other like applications, devices and methods of manufacture.

### BACKGROUND

In 2020, stolen packages totaled 5.4 billion dollars in value. Packages are generally tracked from the warehouse to the delivery location of a consumer. However, after a package is delivered, the tracking number is of no use, especially if the package is stolen from the delivery location after delivery. Currently, no means exist to allow a consumer to track the location of their package after it has been delivered.

Therefore, there exists a long-felt need in the art for a package tracking system. There also exists a long-felt need in the art for a package tracking system that can be easily used with any package. Further, there exists a long-felt need in the art for a package tracking system that allows a user to track the location of their package after it has been delivered especially if the package has been stolen.

The subject matter disclosed and claimed herein, in one embodiment thereof, comprises a package tracking system. The system is primarily comprised of at least one sleeve and at least one tracking device with a body, further comprised of at least one transmitter and at least one label. In the preferred embodiment, the tracking device is encased within the sleeve, wherein the sleeve is adhesive and can be placed inside a package. The transmitter of the tracking device can be activated once inside the package to allow a user to view the GPS location of the package via a mobile application. In this manner, a package the tracking device is in can be tracked if said package is stolen after delivery of the package, but before the package could be received by a consumer.

In this manner, the package tracking system of the present invention accomplishes all of the foregoing objectives and provides a novel package tracking system. The device further provides a package tracking system that can be easily used with any package. Further, the device allows a user to track the location of their package after it has been delivered and if the package has been stolen.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a package tracking system. The system is primarily comprised of at least one sleeve and at least one tracking device with a body, further comprised of at least one transmitter and at least one label. The tracking device is further fixedly or removably encased in a plastic sleeve, wherein all or a portion of the outer surface of the sleeve is adhesive or contains at least one adhesive fastener to allow the sleeve to easily adhere to the interior of a packaging box or package. Therefore, the tracking device can be easily placed and secured into a packaging box in a universal manner.

The top surface of the body is preferably comprised of at least one label that serves as a return label for the tracking device and/or package the tracking device is secured within. In this manner, a lost or stolen tracking device can be returned along with the package the tracking device is secured within. The label preferably has at least one indicia in the form of, but not limited to, text relating to: package owner, package owner address, package owner telephone number/email, tracking device serial number, etc.

The tracking device is further comprised of at least one battery that provides power to at least one transmitter within the body of the tracking device. In differing embodiments, the transmitter may be a GPS antenna transmitter that outputs a GPS location signal that can be received by a smart device, a cellular transmitter with a sim card that allows the tracking device to communicate to a smart device via a cellular signal, and/or a Bluetooth or NFC transmitter.

The system is also comprised of a mobile application that can be used to view the GPS location of the tracking device, wherein the mobile application is in communication with the transmitter. The GPS location may be viewable via a map interface or other viewable interface provided by the mobile application. The mobile application can also be used to confirm a package has been received by a user. The confirmation process may occur automatically via the transmitter once a smart device of a user is within a close enough proximity to the tracking device. In a differing manner, a user can use a camera of a smart device to scan the code to confirm the delivery of the package with the tracking device was received. After delivery is confirmed, the transmitter is preferably disabled until it is re-programmed to be used again. In one embodiment, the tracking device can be re-programmed using the mobile application.

In another embodiment, the transmitter can be activated by pressing at least one button located on the body, which can be done during the shipping process by a shipping worker before a package is sealed for shipping with the tracking device inside. Alternatively, a delivery driver may have a smart device with the mobile application that is in wireless connection with the transmitter, wherein said driver has special administrative permissions, through the mobile application, such that the application can be used to activate the transmitter after the delivery driver has delivered the package the tracking device is in, but before the package has been received by a user. In addition, the transmitter may issue an alert to the mobile application to notify a user if the package is stolen (i.e., the package moves from the delivered location without the delivery being confirmed by the user using the code).

Accordingly, the package tracking system of the present invention is particularly advantageous as it provides a novel package tracking system that can be easily used with any package. In addition, the device allows a user to track the location of their package after it has been delivered and after the package has been stolen. In this manner, the package tracking system provides a novel solution to obtaining the location of packages after they have been stolen from a delivery location before being received by a consumer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a package tracking system of the present invention in accordance with the disclosed architecture;

FIG. 2 illustrates a cross-sectional view of one potential embodiment of a package tracking system of the present invention while secured within a package in accordance with the disclosed architecture;

FIG. 3 illustrates a graphical view of one potential embodiment of a mobile application of one potential embodiment of a package tracking system of the present invention in accordance with the disclosed architecture; and

FIG. 4 illustrates a flow chart of a method of using one potential embodiment of a package tracking system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a package tracking system. There also exists a long-felt need in the art for a package tracking system that can be easily used with any package. Further, there exists a long-felt need in the art for a package tracking system that allows a user to track the location of their package after it has been delivered and if the package has been stolen.

The present invention, in one exemplary embodiment, is comprised of a package tracking system. The system is primarily comprised of at least one sleeve and at least one tracking device with a body, further comprised of at least one transmitter and at least one label. The tracking device is further fixedly or removably encased in a plastic sleeve, wherein all, or a portion, of the outer surface of the sleeve is adhesive or contains at least one adhesive fastener to allow the sleeve to easily adhere to the interior of a packaging box or package. Therefore, the tracking device can be easily placed and secured into a packaging box in a universal manner using the sleeve.

The top surface of the body is preferably comprised of at least one label that serves as a return label for the tracking device and/or package the tracking device is secured within. In this manner, a lost or stolen tracking device can be returned along with the package the tracking device is secured within in a timely manner. The label preferably has at least one indicia in the form of, but not limited to, text relating to: package owner, package owner address, package owner telephone number/email, tracking device serial number, etc.

The tracking device is further comprised of at least one battery that provides power to at least one transmitter within the body of the tracking device. In differing embodiments, the transmitter may be a GPS antenna transmitter that outputs a GPS location signal that can be received by a smart device, a cellular transmitter with a sim card that allows the tracking device to communicate to a smart device via a cellular signal, and/or a Bluetooth or NFC transmitter.

The system is also comprised of a mobile application that can be used to view the GPS location of the tracking device, wherein the mobile application is in communication (preferably wireless electrical communication) with the transmitter. The GPS location may be viewable via a map interface or other viewable interface provided by the mobile application. The mobile application can also be used to confirm a package has been received by a user. The confirmation process may occur automatically via the transmitter once a smart device of a user is within a close enough proximity to the tracking device. In a differing manner, a user can use a camera of a smart device to scan the code to confirm the delivery of the package with the tracking device was received. After delivery is confirmed, the transmitter is preferably disabled until it is re-programmed to be used again. In one embodiment, the tracking device can be re-programmed using the mobile application.

In one embodiment, the transmitter can be activated by pressing at least one button located on the body, which can be done during the shipping process by a shipping worker before a package is sealed for shipping with the tracking device inside. Alternatively, a delivery driver may have a smart device with the mobile application that is in wireless connection with the transmitter, wherein said driver has special administrative permissions through the mobile application, such that the application can be used to activate the transmitter after the delivery driver has delivered the package the tracking device is in, but before the package has been received by a consumer. In addition, the transmitter may issue an alert to the mobile application to notify a user if the package is stolen (i.e., the package moves from the delivered location without the delivery being confirmed by the user using the code).

Accordingly, the package tracking system of the present invention is particularly advantageous as it provides a novel package tracking system that can be easily used with any package. In addition, the device allows a user to track the location of their package after it has been delivered and if the package has been stolen. In this manner, the package tracking system provides a novel solution to obtaining the location of packages if they have been stolen from a delivery location before being received by a consumer.

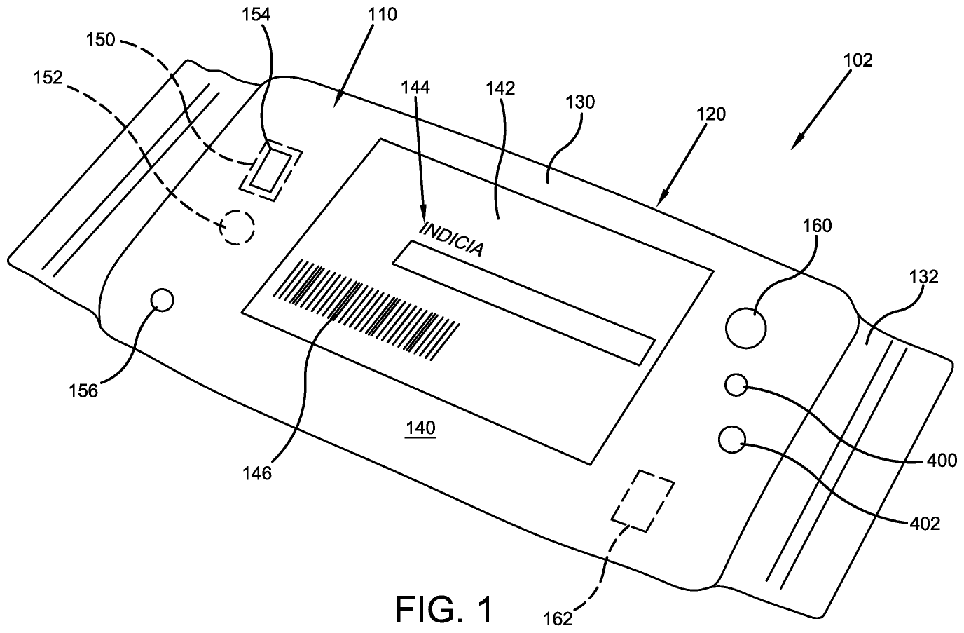

Referring initially to the drawings, FIG. 1 illustrates a perspective view of one potential embodiment of a package tracking system 100 of the present invention in accordance with the disclosed architecture. The system 100 is primarily comprised of at least one sleeve 120 and at least one tracking device 102 with a body 110, further comprised of at least one transmitter 152 and at least one label 142. In various embodiments, the body 110 may be a plurality of shapes such as, but not limited to: square, rectangular, circular, cylindrical, etc. as well as a plurality of sizes. The body 110 is also preferably manufactured from a plastic material such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc.

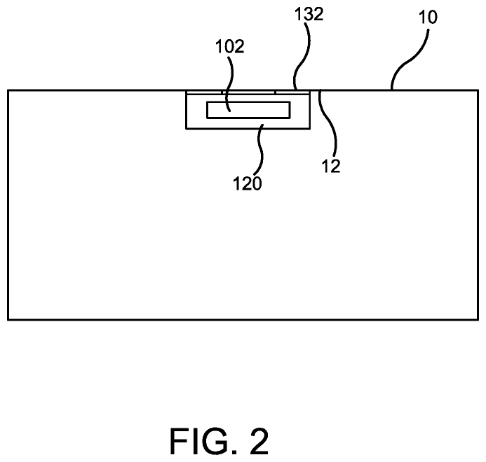

The tracking device 102 is further fixedly or removably encased in a plastic sleeve 120. The sleeve 120 is preferably transparent to allow a label 142 of the body 110 to be easily read while the sleeve 120 surrounds the body 110. In the preferred embodiment, all, or a portion of, the outer surface 130 of the sleeve 120 is adhesive or contains at least one adhesive fastener 132 to allow the sleeve 120 to easily adhere to the interior surface 12 of a packaging box or package 10, as seen in FIG. 2. In this manner, the tracking device 102 can be easily placed and secured to a package 10 in a universal manner.

The top surface 140 of the body 110 is preferably comprised of at least one label 142. The label 142 serves as a return label for the tracking device 102 and/or package 10 the tracking device 102 is secured within. In this manner, a lost or stolen tracking device 102 can be returned along with the package 10 in a timely manner. The label 142 preferably has at least one indicia 144 in the form of, but not limited to, text relating to: package owner, package owner address, package owner telephone number/email, tracking device 102 serial number, RTCA certification, battery information, battery warning statement, CE, FCC, etc. Said information may also be available by scanning at least one scannable code 146 found on the label 142 that may be in the form of, but is not limited to: a 2D barcode, a QR code, etc. Scanning the code 146 may also allow the tracking device 102 to be reprogrammed and/or reset.

The tracking device 102 is further comprised of at least one battery 150. The battery 150 may be a disposable battery 150 or a rechargeable battery 150 in the form of an alkaline, nickel-cadmium, nickel-metal hydride battery 150, etc., such as any 3V-12 volts DC battery 150 or other conventional battery 150, such as A, AA, AAA, etc., that supply power to the tracking device 102. Throughout this specification the terms “battery” and “batteries” may be used interchangeably to refer to one or more wet or dry cells or batteries 150 of cells in which chemical energy is converted into electricity and used as a source of DC power. References to recharging or replacing batteries 150 may refer to recharging or replacing individual cells, individual batteries 150 of cells, or a package of multiple battery cells as is appropriate for any given battery 150 technology that may be used. The battery 150 may be recharged via at least one USB port 154 that may be any USB port such as but not limited to USB C.

The battery 150 provides power to at least one transmitter 152 within the body 110 of the tracking device 102. In one embodiment, the transmitter 152 is an internal or external GPS antenna transmitter that outputs a GPS location signal that can be received by a smart device. In a differing embodiment, the tracking device 102 may additionally or alternatively have a cellular transmitter 152 and sim card 162 that allows the tracking device 102 to communicate to a smart device via a cellular signal. In this manner, the transmitter 152 allows the GPS location of the tracking device 102 (and package the tracking device 102 is within) to be seen by a user. In one embodiment, the transmitter 152 may also be a Bluetooth or NFC transmitter. The transmitter 152 may transmit via global, LTE, CatM-1, NB-loT, GSM, GPRSW, Wi-Fi, etc. The transmitter 152 may be programmed to run on a timer such that the transmitter 152 only transmits for pre-programmed reporting intervals (i.e., every 3 minutes, every 10 minutes, etc.).

The device 100 may also be comprised of at least one accelerometer 156. The accelerometer 156 detects when the device 100 is in motion. When the accelerometer 156 detects motion, the transmitter 156 begins transmitting. In one embodiment, transmitter 156 will stop transmitting when the accelerometer detects no motion. In a further embodiment, the transmitter 152 transmits continuously regardless of motion or non-motion of the device 100.

Further, the tracking device 102 may be comprised of at least one light sensor 400. The light sensor 400 detects light (i.e., when a package 10 with the tracking device 102 inside is opened). The activation of the light sensor 400 may further trigger a message 208 within the mobile application 200 that the package 10 has been opened. Further, the device 102 may have at least one air pressure sensor 402 such that air pressure around the device 102 and package 100 can be viewed by the mobile application 210.

The tracking device 102 is further comprised of at least one LED indicator 158. The indicator 158 may be any color known in the art. In one example, the device 102 as three indicators 158, wherein an indicator of one color indicates the power level of the battery 150, another indicator of another color indicates whether the transmitter 152 is active, and an another indicator of another color indicates whether the cellular transmitter 152 is active.

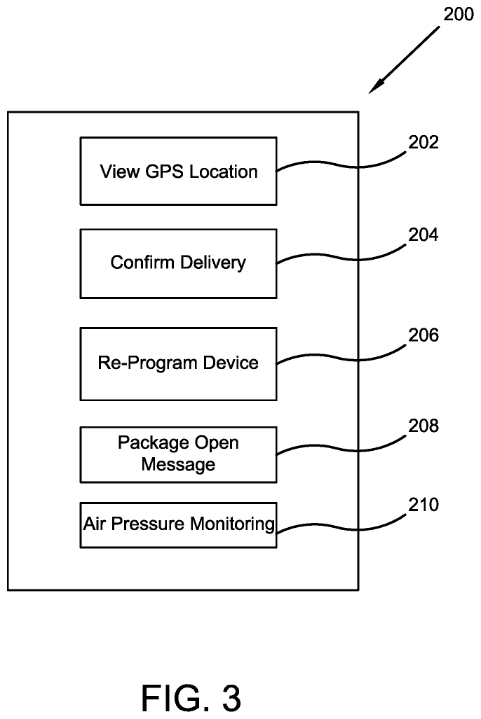

FIG. 3 illustrates a graphical view of one potential embodiment of a mobile application 200 of one potential embodiment of a package tracking system 100 of the present invention in accordance with the disclosed architecture. The system 100 is also comprised of a mobile application 200. The mobile application 200 can be used to view the GPS location of the device 202 when in communication with the transmitter 152. The GPS location may be viewable via a map interface or other viewable interface provided by the mobile application 200. The mobile application 200 can also be used to confirm a package has been received by a user 204. This confirmation process may occur automatically via the transmitter 152 once a smart device of a user is within a close enough proximity to the tracking device 102. Alternatively, a user can use a camera of a smart device to scan the code 146 to confirm the delivery of the package 10. After delivery is confirmed, the transmitter 152 is preferably disabled until it is re-programmed to be used again. In one embodiment, the tracking device 102 can be re-programmed 206 and/or activated or controlled using the mobile application 200.

In another embodiment, the transmitter 152 can be activated by pressing at least one button 160 located on the body 110. This action can be completed during the shipping process by a shipping worker before a package 10 is sealed for shipping with the tracking device 102 inside. Alternatively, a delivery driver may have a smart device with the mobile application 200 that is in wireless connection with the transmitter 152, wherein said driver has special administrative permissions through the mobile application 200, such that the application 200 can be used to activate the transmitter 152 after the delivery driver has delivered the package 10, but before the package has been received by a user. Once this process occurs, the transmitter 152 may issue an alert to the mobile application 200 to notify a user if the package 10 is stolen (i.e., the package 10 moves from the delivered location without the delivery being confirmed by the user using the code 146).

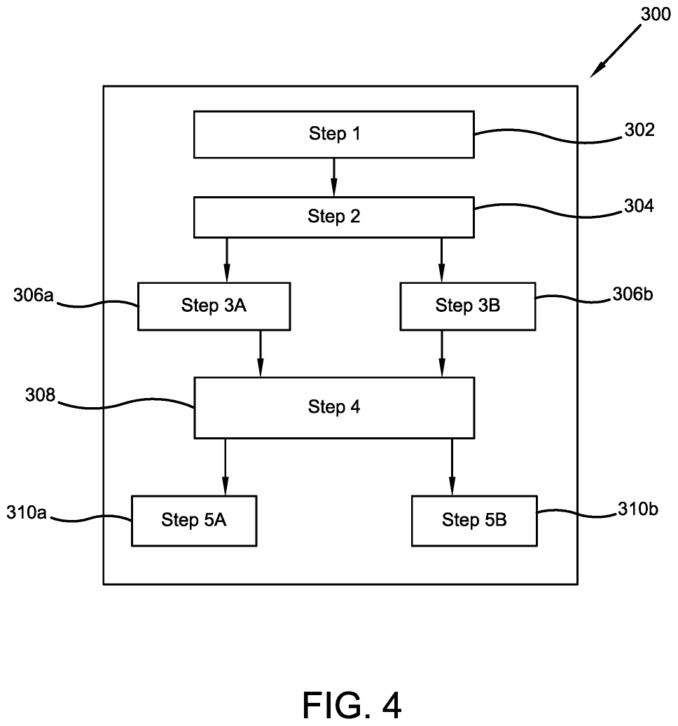

FIG. 4 illustrates a flow chart of a method of using 300 one potential embodiment of a package tracking system 100 of the present invention in accordance with the disclosed architecture. The system 100 may also be comprised of a method of use 300. First, the body 110 of the tracking device 102 is placed within a plastic sleeve 120 [Step 302]. Then, the sleeve 120 is adhered to the interior surface 12 or exterior surface of a package 10 [Step 304]. At this point, the transmitter 152 can be activated using a button 160 or a wirelessly connected smart device with administrative privileges [Step 306A]. Alternatively, the transmitter 152 can be activated using a wirelessly connected smart device with administrative privileges after the package the tracking device 102 is in has been delivered [Step 306B]. After the transmitter 152 is activated, the GPS location of the tracking device 102 and the package 10 can be viewed by the mobile application 200 [Step 308]. A user can then use a smart device to scan the code 146 of the body 110 to confirm successful delivery of the package 10 [Step 310A]. Alternatively, the transmitter may automatically confirm the delivery when a smart device of the user is within close proximity to the package 10 [Step 310B].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “package tracking system” and “system” are interchangeable and refer to the package tracking system 100 of the present invention.

Notwithstanding the foregoing, the package tracking system 100 of the present invention and its various components can be of any suitable size and configuration as is known in the art without affecting the overall concept of the invention, provided that they accomplish the above-stated objectives. One of ordinary skill in the art will appreciate that the size, configuration and material of the package tracking system 100 as shown in the FIGS. are for illustrative purposes only, and that many other sizes and shapes of the package tracking system 100 are well within the scope of the present disclosure. Although the dimensions of the package tracking system 100 are important design parameters for user convenience, the package tracking system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A package tracking system comprising:
a tracking device comprised of a label, a transmitter, and a battery;
a sleeve; and
a mobile application.

2. The package tracking system of claim 1, wherein the tracking device is enclosed in the sleeve.

3. The package tracking system of claim 2, wherein an outer surface of the sleeve is covered with an adhesive.

4. The package tracking system of claim 1, wherein the transmitter is a GPS transmitter.

5. The package tracking system of claim 4, wherein a GPS location of the transmitter can be viewed by the mobile application.

6. The package tracking system of claim 1, wherein the transmitter is a cellular transmitter.

7. The package tracking system of claim 6, wherein the tracking device further comprises a SIM card.

8. A package tracking system comprising:
a tracking device comprised of a label, a transmitter and a battery;
a sleeve having an outer surface and a fastener; and
a mobile application in wireless communication with the transmitter.

9. The package tracking system of claim 8, wherein the label is a return label that contains an indicia.

10. The package tracking system of claim 9, wherein the label is comprised of a code that can be scanned.

11. The package tracking system of claim 10, wherein the code is a QR code or a barcode.

12. The package tracking system of claim 8, wherein the transmitter of the tracking device can be activated by the mobile application.

13. The package tracking system of claim 8, wherein the sleeve is comprised of a transparent material.

14. The package tracking system of claim 8, wherein the transmitter is a GPS transmitter, a cellular transmitter, a Bluetooth transmitter or an NFC transmitter.

15. The package tracking system of claim 8, wherein the tracking device is further comprised of a button that activates the transmitter.

16. A method of using a package tracking system, the method comprising the steps of:
placing a tracking device within a sleeve;
adhering the sleeve to a package;
activating a transmitter of the tracking device to track a location of the package; and
viewing a GPS location of the transmitter via a mobile application.

17. The method of claim 16, wherein the transmitter can be activated by a smart device using the mobile application or by a button on the tracking device.

18. The method of claim 17, wherein the transmitter can be activated after the tracking device has been adhered to the package or after the package has been delivered to a recipient party.

19. The method 17, wherein a code on the tracking device can be scanned by a recipient party to confirm delivery of the package.

20. The method of claim 19, wherein the transmitter automatically confirms the delivery when in close proximity to a smart device with the mobile application installed.
